(19) United States
(12) Patent Application Publication
(10) Pub. No.: US 2006/0128178 A1
(43) Pub. Date: Jun. 15, 2006

(54) IC socket and test method using the same

(75) Inventor: Hideo Ikejiri, Tokyo (JP)

Correspondence Address: TAKEUCHI & KUBOTERA, LLP, Suite 202, 200 Daingerfield Road, Alexandria, VA, 22314, US

(73) Assignee: Oki Electric Industry Co., Ltd.

(21) Appl. No.: 11/226,207

(22) Filed: Sep. 15, 2005

(30) Foreign Application Priority Data
Dec. 10, 2004 (JP) 2004-358707

(51) Int. Cl. H01R 12/00

(52) U.S. Cl. 439/73

(57) ABSTRACT

An IC socket includes a base portion having a support portion for supporting an IC device, and an external connection terminal for inputting a signal to the IC device and outputting a signal from the IC device; a lid portion having a pressing portion with a movable first projecting portion for pressing the IC device, and a fixing portion to be fixed to the base portion; and a first hinge for supporting the base portion and the lid portion to be movable.

### BACKGROUND OF THE INVENTION AND RELATED ART STATEMENT

The present invention relates to an IC socket and a test method of using the IC socket. Especially, the present invention relates to an IC socket for conducting an electrical characteristic test of an IC device such as a CSP (Chip Size Package) having an electrode in an area allay shape.

Recently, it has been required to reduce a size and a weight of an electrical device such as a mobile electrical device. To this end, a CSP is mounted on and connected to a substrate with soldering as an IC device. Due to a small size of the IC device, it is difficult to directly input and output an electrical signal into and from the IC device itself, and it is necessary to provide a device called an IC socket for supporting the input and output of the electrical signal. Patent Reference 1 has disclosed such an IC socket.

Patent Reference 1: Japanese Patent Publication No. 2001-013207

In the IC socket disclosed in Patent Reference 1, when a lid is released from a pressurized state and an IC device is removed from the IC socket, the IC device tends to stick to a pressurized portion of the lid. This phenomenon may be caused by static charge generated during a test, moisture, or a sticky resin as well as a lightweight of the IC device. Especially when the IC device has a size less than 5 mm square, the phenomenon occurs more frequently. Once the IC device sticks to the IC socket, it is necessary to perform an additional step of taking out the IC device, thereby increasing a test time.

In view of the problems described above, an object of the present invention is to provide an IC socket capable of preventing an IC device from sticking to a pressurized portion of the IC socket, thereby making it possible to reduce test time. Another object of the present invention is to provide a test method using the IC socket.

Further objects and advantages of the invention will be apparent from the following description of the invention.

### SUMMARY OF THE INVENTION

In order to attain the objects described above, according to the present invention, an IC socket includes a base portion having a support portion for supporting an IC device, and an external connection terminal for inputting a signal to the IC device and outputting a signal from the IC device; a lid portion having a pressing portion with a movable first projecting portion for pressing the IC device, and a fixing portion to be fixed to the base portion; and a first hinge for supporting the base portion and the lid portion to be movable.

According to the present invention, a test method includes a step of preparing an IC socket including a base portion having a support portion for supporting an IC device, and an external connection terminal for inputting a signal to the IC device and outputting a signal from the IC device; a lid portion having a pressing portion with a movable first projecting portion for pressing the IC device, and a fixing portion to be fixed to the base portion; and a first hinge for supporting the base portion and the lid portion to be movable; a step of mounting the IC device on the supporting portion; and a step of removing the IC device from the supporting portion.

In the present invention, when the IC socket is used in an electrical property test, it is possible to prevent the IC device from sticking to the pressing portion of the IC socket, thereby eliminating tedious manual operations and reducing test time.

### BRIEF DESCRIPTION OF THE DRAWINGS

FIG. 1 is a perspective view showing an IC socket according to a first embodiment of the present invention;

FIG. 2 is a sectional view of the IC socket according to the first embodiment of the present invention taken along line 2-2 in FIG. 1;

FIG. 3 is a sectional view showing an IC socket according to a second embodiment of the present invention;

FIG. 4 is a sectional view of the IC socket according to the first embodiment of the present invention; and

FIG. 5 is a sectional view showing a modified example of the IC socket according to the first embodiment of the present invention.

### DETAILED DESCRIPTION OF PREFERRED EMBODIMENTS

Hereunder, embodiments of the present invention will be explained with reference to the accompanying drawings.

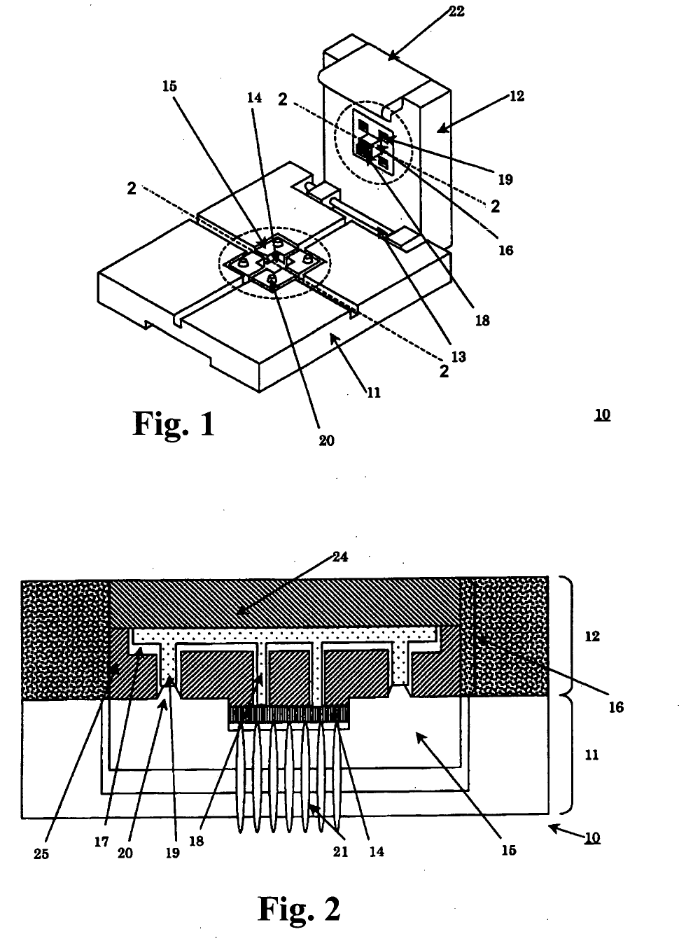

FIG. 1 is a perspective view showing an IC socket according to a first embodiment of the present invention. FIG. 2 is a sectional view of the IC socket according to the first embodiment of the present invention taken along line 2-2 in FIG. 1. First, the IC socket of the first embodiment will be explained with reference to FIG. 1.

An IC socket 10 includes a base portion 11; a lid portion 12; and a first hinge 13. A supporting portion 15 with a recessed shape is disposed at a center of the base portion 11 for mounting an IC device 14. A pressing portion 16 with a protruding shape is disposed at the center of the lid portion 12 to face the supporting portion 15. The pressing portion 16 has a space 17 inside thereof. First projecting portions 18 are disposed in the space 17. The first projection portions 18 are formed such that the first projecting portions 18 extend and contract from a surface of the pressing portion 16 contacting with the IC device 14 when the IC device 14 is mounted. Adjusting portions 19 are disposed in the space 17 for adjusting the extension and contraction of the first projection portions 18. The adjusting portions 19 and the first projection portions 18 are integrated together.

Second projecting portions 20 are disposed on the supporting portion 15 to face the adjusting portions 19. External connection terminals 21 are disposed in the supporting portion 15, so that the external connection terminals 21 extend or can extend from a surface of the supporting portion 15 for mounting the IC device 14 thereon. The external connection terminals 21 are embedded in the base portion 11 from the supporting portion 15 and extend from the surface for mounting the IC device 14 to an opposite surface to be connected to a conductive pattern board. The lid portion 12 is provided with a fixing portion 22 on a side opposite to the first hinge 13 for fixing to the base portion 11.

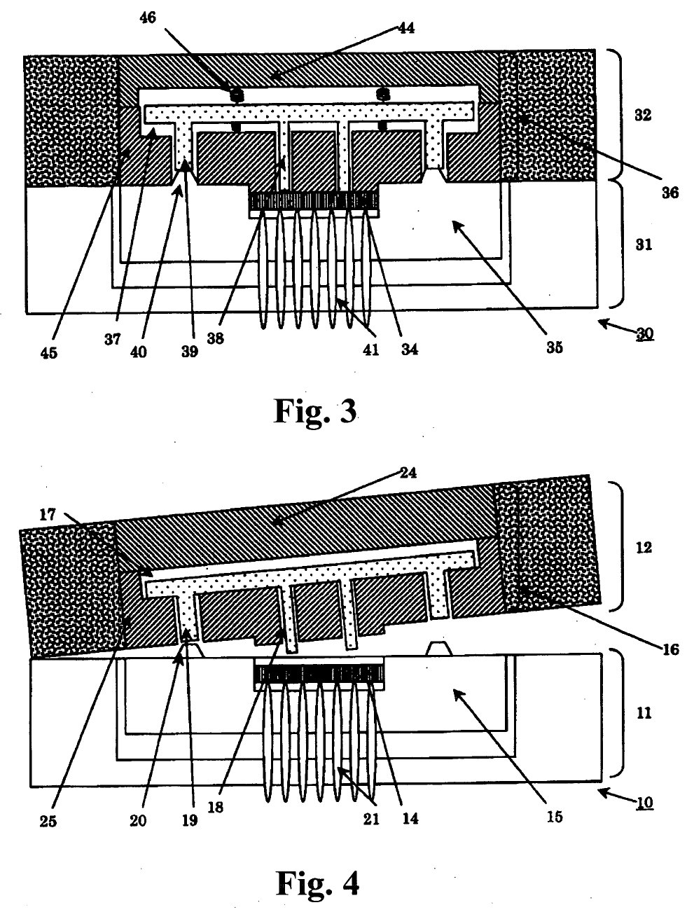

An operation of the IC socket 10 will be explained next with reference to FIG. 2 and FIG. 4. FIG. 2 is a sectional view of the IC socket 10 in a state that the IC device 14 is mounted on the supporting portion 15 and the lid portion 12 of the IC socket 10 is closed. In the closed state of the lid portion 12, the adjusting portions 19 are pushed upwardly with the second projecting portions 20. Accordingly, the first projection portions 18 integrated with the adjusting portions 19 are retained in the pressing portion 16.

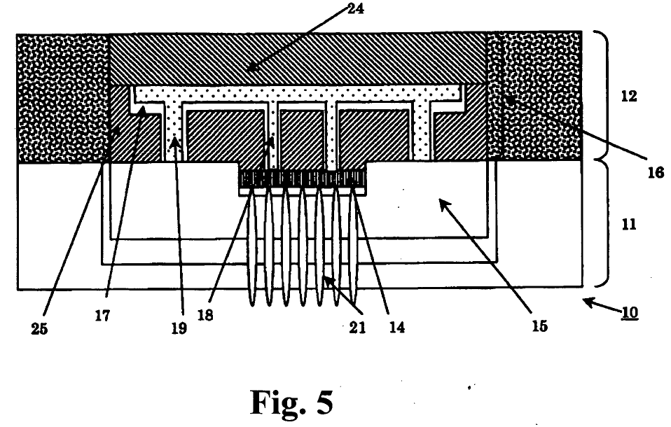

The second projecting portions 20 have a shape with a size reducing toward an upper side, so that the second projecting portions 20 are not caught when the lid portion 12 is opened. The second projecting portions 20 have a specific height to be determined through a design, so that the second projecting portions 20 and the adjusting portions 19 move smoothly. When the adjusting portions 19 have an enough length as shown in FIG. 5, it is possible to omit the second projecting portions 20.

A state that the IC socket 10 is opened will be explained next. FIG. 4 shows the state that the IC socket 10 is opened from the state shown in FIG. 2. When the lid portion 12 is opened upwardly, the second projecting portions 20 no longer support the adjusting portions 19, so that the adjusting portions 19 and the first projection portions 18 move downwardly in the space 17 with gravity. Accordingly, the first projection portions 18 retained in the pressing portion 16 protrude from the pressing portion 16. Therefore, even if the IC device 14 sticks to the pressing portion 16 when the lid portion 12 is opened, it is possible to remove the IC device 14 with the first projection portions 18.

In the embodiment, the pressing portion 16 may be movably attached to the lid portion 12 through a second hinge, so that it is possible to prevent a local pressure from being applied to the IC device 14. Further, the supporting portion 15 is movably attached to the base portion 11 through the external connection terminals 21, so that it is possible to further prevent a local pressure from being applied to the IC device 14. When a pressure is applied to the supporting portion 15 from the pressing portion 16, the external connection terminals 21 are arranged to protrude from the surface of the supporting portion 15 mounting the IC device 14 thereon. Accordingly, it is possible to securely connect the IC device 14 to the external connection terminals 21.

The pressing portion 16 includes an upper pressing portion 24 and a lower pressing portion 25. The space 17 is formed between the upper pressing portion 24 and the lower pressing portion 25 for retaining the first projection portions 18 and the adjusting portions 19. When the upper pressing portion 24 and the lower pressing portion 25 are separately formed, it is easy to assemble the IC socket 10.

A test method using the IC socket 10 will be explained next. First, the IC socket 10 described above is prepared. Then, the IC device 14 is mounted on the supporting portion 15 of the IC socket 10, and the lid portion 12 of the IC socket 10 is closed. A tester is connected to the IC socket 10 for conducting a test. After the test, the lid portion 12 of the IC socket 10 is opened to take out the IC device 14.

In the test method of the present invention, it is possible to prevent the IC device 14 from sticking to the pressing portion 16 when the lid portion 12 of the IC socket 10 is opened. Accordingly, it is possible to smoothly take out the IC device 14.

FIG. 3 is a sectional view showing an IC socket according to a second embodiment of the present invention. In the second embodiment, only differences from the first embodiment will be explained.

An IC socket 30 includes first projecting portions 38; adjusting portions 39; and elastic members 46 disposed between the projecting portions 38 and an inner surface of a pressing portion 36. The elastic members 46 are formed of a spring or a resin. The elastic members 46 are disposed at an upper side or a lower side of the first projecting portions 38 and the adjusting portions 39, or both of the upper side and lower side of the first projecting portions 38 and the adjusting portions 39. It is possible to adjust a force of the elastic members 46 applied to the first projecting portions 38 and the adjusting portions 39 through adjusting spring modulus and extension.

When the spring modulus and extension are adjusted so that the force of the elastic members 46 is applied downwardly upon opening the lid portion, even if the first projecting portions 38 and the adjusting portions 39 have lightweight due to a material, it is still possible to smoothly remove an IC device 34. On the other hand, when the spring modulus and extension are adjusted so that the force of the elastic members 46 is applied upwardly upon opening the lid portion, even if the first projecting portions 38 and the adjusting portions 39 are made of metal, it is possible to absorb an impact on the IC device 34 when the IC device 34 is removed.

The disclosure of Japanese Patent Application No. 2004-358707, filed on Dec. 10, 2004, is incorporated in the application.

While the invention has been explained with reference to the specific embodiments of the invention, the explanation is illustrative and the invention is limited only by the appended claims.

What is claimed is:

1. An IC socket for mounting an IC device, comprising:
a base portion having a supporting portion for supporting the IC device, and an external connection terminal for inputting a signal to the IC device and outputting a signal from the IC device;
a lid portion having a pressing portion for pressing the IC device and a fixing portion to be fixed to the base portion, said pressing portion including a first projecting portion; and
a first hinge for supporting the base portion and the lid portion to be movable.

2. The IC socket according to claim 1, wherein said supporting portion have a shape recessing relative to the base portion, and said pressing portion has a shape protruding relative to the lid portion.

3. The IC socket according to claim 1, wherein said pressing portion includes a regulating portion for regulating the first projecting portion.

4. The IC socket according to claim 3, wherein said regulating portion is integrated with the first projecting portion.

5. The IC socket according to claim 3, wherein said pressing portion further includes an opening for passing the regulating portion and the first projecting portion.

6. The IC socket according to claim 1, wherein said pressing portion includes an upper pressing portion and a lower pressing portion.

7. The IC socket according to claim 3, wherein said pressing portion further includes a space for retaining the regulating portion and the first projecting portion.

8. The IC socket according to claim 3, wherein said pressing portion includes an upper pressing portion and a lower pressing portion.

9. The IC socket according to claim 8, further comprising an elastic member for connecting the regulating portion and the first projecting portion to the upper pressing portion.

10. The IC socket according to claim 1, wherein said base portion further includes a second projecting portion.

11. The IC socket according to claim 10, wherein said second projecting portion is arranged to regulate the regulating portion and the first projecting portion when the pressing portion presses the IC device.

12. The IC socket according to claim 1, further comprising a second hinge for attaching the pressing portion to the lid portion to be movable, said pressing portion being formed independently from the lid portion.

13. The IC socket according to claim 1, wherein said supporting portion is arranged to be movable in a vertical direction.

14. The IC socket according to claim 1, wherein said external connection terminal is arranged to be capable of extending and contracting, said supporting portion moving in a vertical direction when the external connection terminal extends or contracts.

15. The IC socket according to claim 1, wherein said external connection terminal is arranged to connect to the IC device according to a movement of the supporting portion.

16. The IC socket according to claim 1, wherein said base portion further includes a groove portion extending from the supporting portion toward an outer surface of the base portion.

17. A test method of testing an IC device, comprising the steps of:
preparing the IC socket according to claim 1;
mounting the IC device on the supporting portion;
closing the lid portion;
conducting a test on the IC device;
opening the lid portion; and
removing the IC device from the IC socket.

18. The test method according to claim 17, further comprising the step of connecting a tester to the IC socket.
